(19) United States
(12) Patent Application Publication
(10) Pub. No.: US 2014/0326756 A1
(43) Pub. Date: Nov. 6, 2014

(54) ADJUSTABLE VOLUME CONDIMENT DISPENSER

(71) Applicant: J.R. Simplot Company, Boise, ID (US)

(72) Inventors: David B. Walker, Meridian, ID (US); John H. Kobs, IV, Meridian, ID (US); Lorin L. Forester, Nampa, ID (US); Tracy R. Hitchcock, Boise, ID (US); Daniel L. Ward, Caldwell, ID (US)

(21) Appl. No.: 13/943,734

(22) Filed: Jul. 16, 2013

Related U.S. Application Data
(60) Provisional application No. 61/672,696, filed on Jul. 17, 2012.

(51) Int. Cl. B65D 37/00; G01F 11/00

(52) U.S. Cl. CPC B05B 11/3029; B05B 11/0089; B05B 11/3042
USPC 222/207; 222/309

(57) ABSTRACT

An improved and variable adjustable condiment dispenser, and a related externally adjustable dispense handle, are provided for use in dispensing a variable but metered quantity of a selected viscous but flowable condiment, such as guacamole sauce, in a restaurant facility or the like, wherein the dispense handle is adjustably set at one of several different dispense volumes without requiring opening of the dispenser or sanitation thereof.

### BACKGROUND OF THE INVENTION

This invention relates generally to an improved condiment dispenser for variably dispensing a relatively viscous but flowable condiment, such as guacamole sauce, without requiring the dispenser to be opened or sanitized between external adjustments in dispensed volume. More particularly, this invention relates to an improved condiment dispenser and related externally adjustable dispense handle for variably dispensing a selected quantity of the condiment in a fast food restaurant facility or the like.

Condiments such as relatively viscous but flowable substances including but not limited to catsup, mustard, guacamole sauce and the like are often applied to sandwiches, etc., particularly in so-called fast food restaurants by employees and/or by consumers. In this regard, it is highly desirable to dispense such condiments in a clean and sanitary fashion, and in a variable quantity depending upon the specific type and use of the condiment being dispensed.

The present invention relates to an improved variable quantity condiment dispenser, and a related adjustably set dispense handle, wherein the dispense handle is quickly and easily moved to and set at a desired metered dispense quantity, without requiring the dispenser to be opened and further without compromising condiment sanitation.

### SUMMARY OF THE INVENTION

In accordance with the invention, an improved and variably adjustable condiment dispenser, and a related externally adjustable dispense handle, are provided for use in dispensing a variable but metered quantity of a selected viscous but flowable condiment, such as guacamole sauce, in a restaurant facility or the like. The dispense handle is adjustably set at one of several different dispense volumes without requiring opening of the dispenser or jeopardizing the sanitation thereof.

The invention utilizes a condiment dispenser which generally includes a reservoir for receiving the selected condiment, and a pump or pump mechanism for dispensing the selected condiment. In general, and in a relatively simple form, the pump mechanism comprises a chamber formed in part by a resilient bladder. A draw tube extends from the chamber downwardly into the selected condiment in the reservoir, whereas a dispense tube extends from the chamber to the exterior of the reservoir for dispensing the selected condiment. Each of the draw tube and the dispense tube includes a one-way check valve for respectively permitting the condiment to be drawn upwardly into the chamber, and for permitting the condiment to be pumped from the chamber through the dispense tube.

The dispense handle is pivotally carried by a reservoir lid for depression to advance a structure such as a wheel against the chamber bladder to reduce the volume of the chamber, and/or corresponding upward movement to withdraw the wheel or the like from the bladder to increase the bladder chamber volume. The dispense handle is desirably spring-loaded for normal upward movement relative to the reservoir lid. During upward movement of the dispense handle, the condiment is drawn from the reservoir through the draw tube and associated check valve into the chamber. During downward motion of the dispense handle relative to a central slot formed in the reservoir lid, the condiment is prevented by the draw tube check valve from moving back into the reservoir, but is instead pumped out through the dispense tube and associated check valve for dispensing.

In one preferred form of the invention, the stroke length of the dispense handle is variably selected to correspondingly variably select the quantity of dispensed condiment. In the preferred form, a plurality of thumb screws with asymmetric heads are rotatably carried by the dispense handle near the end thereof opposite the pivot joint on the reservoir lid. The asymmetric heads of these multiple thumb screws can be adjustably rotated about the axis of the associated thumb screw to fit into a relatively narrow widened slot segment of the central slot formed in the reservoir lid, or alternately not to fit through the narrow widened slot segment and thereby limit downward stroke length of the dispense handle. By way of example, three such thumb screws each with asymmetric heads can be mounted at one side of the dispense handle, with the first such thumb screw head rotated not to fit through the narrow widened slot portion defining a limit or stop to dispense handle stroke length and thus also the dispensed condiment quantity.

In an alternative preferred form of the invention, a generally U-shaped bow having inturned opposite ends can be mounted for pivoting motion with the dispense handle as it is moved between the depressed and elevated positions. The inturned opposite ends of the U-shaped bow are adapted to fit into a corresponding pair of aligned ports formed in the sides of the dispense handle at a location generally opposite the pivot point on the reservoir lid. The U-shaped bow strikes the top surface of the reservoir lid to define a limit or stop to downward displacement of the dispense handle, in accordance with the specific set of ports into which the bow inturned ends are fitted, to correspondingly define the dispensed condiment quantity.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is an enlarged and fragmented perspective view showing the dispense handle of a condiment dispenser of the present invention in a retracted or elevated position;

FIG. 2 is a somewhat schematic side elevation view depicting the condiment dispenser and related dispense handle of FIG. 1;

FIG. 3 is an enlarged and fragmented perspective view similar to FIG. 1, but showing the dispense handle in a depressed position;

FIG. 4 is an enlarged and fragmented side elevation view similar to a portion of FIG. 2, and illustrating the dispense handle in the depressed position;

FIG. 5 is a further enlarged and fragmented side elevation view similar to FIG. 4, but showing the condiment dispenser and related dispense handle in a retracted or elevated position in accordance with an alternative preferred form of the invention; and

FIG. 6 is a fragmented sectional view of the alternative embodiment taken generally on the line 6-6 of FIG. 5.

### DETAILED DESCRIPTION OF THE PREFERRED EMBODIMENTS

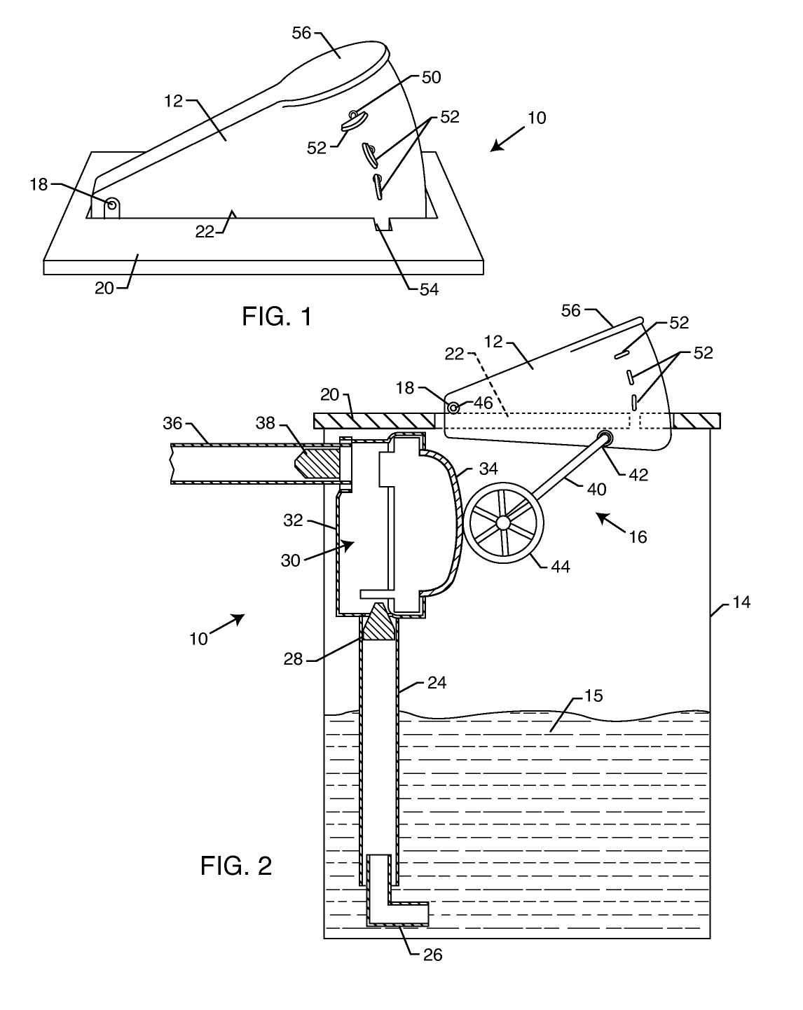

The present invention relates to an improved adjustable condiment dispenser referred to generally in FIG. 1 by the reference numeral 10, and a related externally adjustable dispense handle 12 (FIG. 1-4), wherein the dispense handle 12 is quickly and easily adjustable for dispensing one of several predetermined volumes of a selected condiment, without requiring the dispenser 10 to be opened and/or without compromising dispenser sanitation.

In general terms, the condiment dispenser 10 of the present invention is designed for use in accurate dispensing of a metered volume of a selected condiment, such as guacamole sauce or the like, wherein the condiment is relatively thick or viscous but otherwise flowable. The dispenser 10 accommodates quick and intuitively easy condiment dispensing in a metered per-stroke volume, thereby encouraging use of a non-wasteful portion in a fast food restaurant or the like. The dispenser 10 is quickly and easily adjustable between one of several different metered dispense quantities, without requiring the dispenser 10 to be opened and/or further without compromising dispenser sanitation. This ease of dispenser adjustment, in combination with the fact that the dispenser is not opened during adjustment to prevent contamination of the contained condiment, renders the dispenser particularly useful in a fast food restaurant environment for use in dispensing the selected condiment by restaurant personnel, or by restaurant patrons.

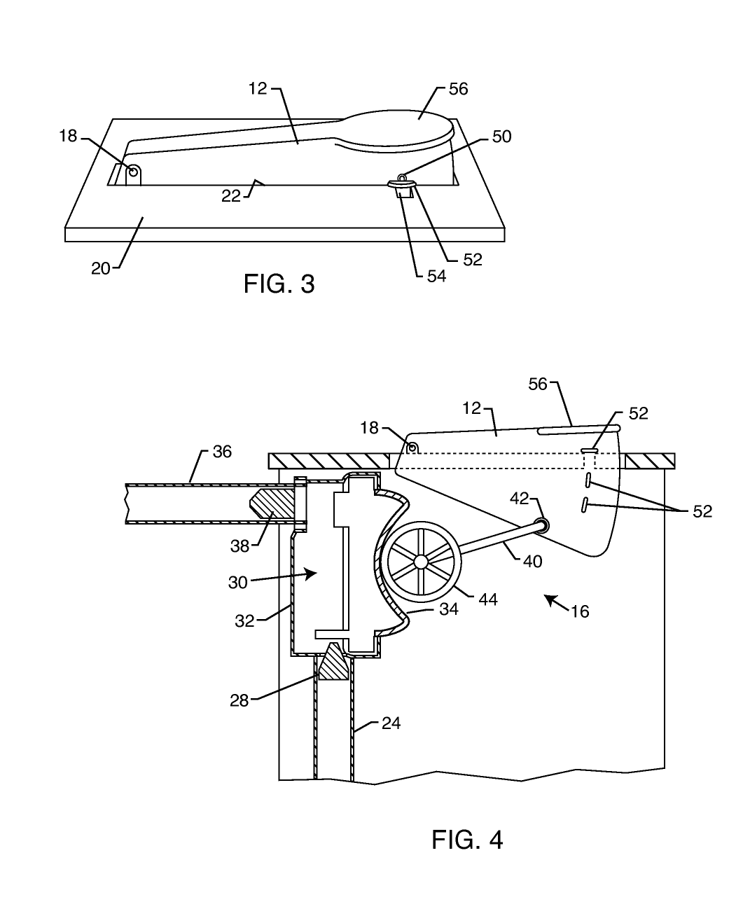

More specifically, in accordance with the invention, and as depicted generally in FIGS. 1 and 2, the condiment dispenser 10 comprises a suitable open-topped container or reservoir 14 for containing a selected quantity of the condiment 15, such as catsup, mustard, guacamole sauce, or the like. Alternately, persons skilled in the art will recognize and appreciate that the condiment 15 can be placed into the reservoir 14 in an open-topped bag, or in a bag adapted to be pierced by a sharpened end 26 of a draw tube 24, if desired (to be described). In either case, a dispensing pump or pump mechanism 16 is operated by reciprocal down and up strokes of the dispense handle 12 which is mounted by means of a pivot pin 18 on a reservoir lid 20. An elongated slot 22 (FIGS. 2-3) is formed in the lid 20 to accommodate the desired down-up reciprocal motion of the dispense handle 12.

In the illustrative drawing (FIG. 1), the pump or pump mechanism 16 includes the downwardly projecting draw tube 24 having the lower end 26 preferably turned generally horizontally or the like for inflow of the condiment 15 upwardly within the draw tube 24 and through a one-way check valve 28 into a pump mechanism chamber 30. In this regard, the illustrative chamber 30 comprises a variable volume chamber having an upright and relative rigid wall 32 at one side thereof. However, an opposite side wall defining the chamber 30 is formed by a resilient bladder 34 shown in FIG. 2 extending to a substantially full size chamber. As shown in FIG. 4, however, the bladder 34 is partially collapsed to reduce the volumetric size of the chamber 30, whereupon the draw tube check valve 28 precludes condiment downflow through the draw tube 24. Instead, the condiment 15 is forced to flow from the reduced-side chamber 30 outwardly through a dispense tube 36 having another one-way check valve 38 installed therein. That is, the check valve 38 is oriented to open in response to reduced chamber volume for dispensing the condiment 15 outwardly from the reservoir 14 through the dispense tube 36.

The dispense handle 12, which is pivotally mounted on the reservoir lid 20 for down-up reciprocal motion relative to the lid slot 22, controls the actual volume of condiment 15 dispensed on a per-stroke basis. That is, the dispense handle 12 is connected by a link 40 pivoted thereto by a pin 42 located beneath the reservoir lid 20 (FIG. 2) to a wheel 44 bearing against the bladder 34 defining the pump chamber 30. When the dispense handle 12 is manually depressed from the upper position shown in FIG. 2 toward a lower or depressed position shown in FIG. 4, the wheel 44 bears against the bladder 34 to reduce the volumetric size of the chamber 30. Conversely, when the dispense handle 12 is released, a spring 46 (FIG. 2) at the pivot pin 18 urges the dispense handle 12 back upwardly from the lower position (FIG. 4) toward the upper or elevated position (FIG. 2) to increase the volumetric size of the chamber 30. Accordingly, reciprocal stroking of the dispense handle 12 is effective to pump the condiment 15 from the chamber 30 when the handle 12 is depressed, and is also effective to draw the condiment 15 into the chamber 30 when the handle 12 is allowed to rise. The check valves 28 and 38, of course, respectively close and open when the dispense handle 12 is depressed, and respectively open and close when the dispense handle 12 is allowed to rise.

The dispense handle 12 stroke length is variably adjustable from the exterior or outside of the reservoir 14 to selectively vary the condiment volume being dispensed on a per-stroke basis. More particularly, as shown with respect to one preferred form in FIGS. 1-4, a series or plurality of thumb screws 50 each having an asymmetric head 52 are threaded respectively into threaded ports located near the end of the dispense handle 12 opposite the pivot pin 18. These thumb screws 50 are oriented in an arcuate array to fit without interference into and through a widened slot segment 54 (FIGS. 1 and 3) near the end of the lid slot 22, depending upon the orientation of the asymmetric screw head 52. That is, in the illustrative drawings, three thumb screws 50 are shown. Two of the thumb screw heads 52 are rotatably turned and set to fit without interference into and through the widened slot segment 54 (FIGS. 2 and 4), whereas the uppermost one of the thumb screw heads 52 is turned generally perpendicularly (FIGS. 1-4) relative to the other thumb screw heads 52 and thereby does not fit into the widened slot segment 54. Instead, the uppermost one of the thumb screw heads 52 contacts the upper side of the reservoir lid 20 and thus defines a limit or stop preventing further downward stroke motion of the dispense handle 12. By controlling or regulating the length of the dispense handle stroke, the volumetric capacity of the pump mechanism 16 is correspondingly limited.

The thumb screw heads 52 can be rotatably adjusted and set so that any one, or none, of the thumb screw heads 52 contacts the reservoir lid 22 instead of fitting without interference through the widened slot segment 54. Accordingly, with three thumb screws 50 as shown, the dispenser 10 can be quickly and easily set at any one of four predetermined volumetric dispense settings, all without requiring the dispenser 10 to be opened and/or compromising the sanitation of the condiment 15. Of course, if all of the thumb screw heads 52 are turned to fit through the widened slot segment 54 without interference, a widened push pad 56 of the dispense handle 12 provides a stop engaging the upper side of the reservoir lid 22 to define a full stroke and a corresponding maximum volume condiment delivery from the dispenser 10.

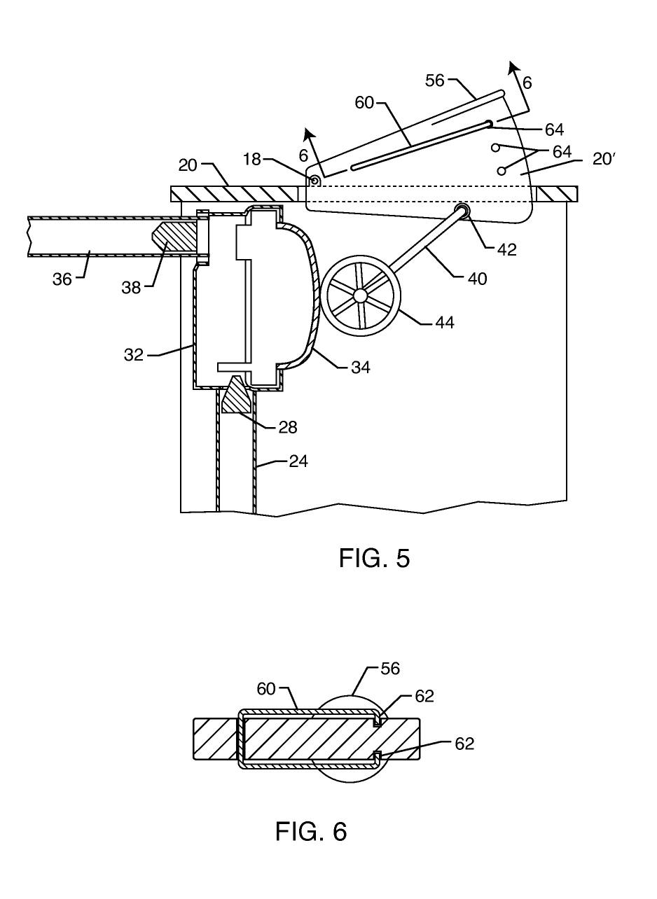

FIGS. 5 and 6 show an alternative preferred form of the invention, wherein a generally U-shaped bow 60 with short inturned opposite ends 62 is provided to limit and/or to regulate the stroke length of a modified dispense handle 12′, instead of the thumb screws 50 as shown in FIGS. 1-4. The balance of the pump mechanism 16 and the condiment reservoir 14 generally conforms with the depiction in FIGS. 1-4, and thus is referred to by common reference numerals.

More particularly, as shown in FIGS. 5 and 6, the modified dispense handle 12′ is mounted near a front end thereof by a pivot pin 18 for reciprocal down-up movement through a reservoir lid 20 having a matingly sized, elongated slot 22 formed therein. During downward stroke motion, a link 40 having a wheel 44 at a free end thereof contacts the resilient bladder 34 defining a portion of the pump chamber 30 to close the check valve 28 within a draw tube 24, and to open a check valve 38 within a dispense tube 36. Conversely, during upward movement of the dispense handle 12′, the opposite happens, namely, the condiment is drawn upwardly through the draw tube 24 and the now-open check valve 28, whereas the check valve 38 in the dispense tube 36 closes. A spring (not shown in FIG. 5) associated with the pivot pin 18 permits the modified dispense handle 12′ to rise when released.

The bow 60 has a generally U-shaped configuration with a front bight segment fitted through the dispense handle 12′ near the pivot pin 18. From the bight segment, the bow 60 extends generally rearwardly along both sides of the dispense handle 12′, and terminates near a rear end thereof in the spaced-apart but inturned ends 62. The bow 60 has sufficient resilience to permit these inturned ends 62 to be fitted into one of a plurality of open side ports 64 formed in an arcuate path and in aligned pairs at the opposite sides of the dispense handle 12′. By fitting the inturned ends 62 into a selected aligned pair of the side ports 64 at the opposite sides of the dispense handle 12′, the bow legs engage or contact the upper side of the reservoir lid 20 to define a limit or stop to dispense handle stroke length.

As shown in FIGS. 5 and 6, three open side ports 64 are formed in an arcuate path at the side of the dispense handle 12′, beneath an upper push pad 56 thereon. Accordingly, these three side ports 64 cooperate with the push pad 56 to define four different stop settings for the dispense handle 12′, corresponding with four different volumetric dispense quantities from the pump mechanism, is direct association with the dispense handle stroke length. That is, the bow inturned ends 62 can be fitted into any one of the aligned pairs of side ports to define three different dispense handle stroke lengths, with omission of the bow 60 defining a fourth dispense handle stroke length with a stop defined by the widened push pad 56 on the handle 12′.

A variety of further modifications and improvements in and to the improved condiment dispenser and related adjustable dispense handle will be apparent to persons skilled in the art. Accordingly, no limitation on the invention is intended by way of the foregoing description, except as set forth in the appended claims.

What is claimed is:

1. A condiment dispenser, comprising:
a reservoir for containing a selected condiment;
a pump within said reservoir and including a draw tube and a dispense tube; and
a lid mounted on said reservoir, said lid having a handle pivotally mounted thereon and reciprocal from the exterior of said lid to operate said pump, said handle being associated with a pair of adjustable stops at the exterior of said lid for limiting the handle stroke length for variably selecting the dispensed volume of the selected condiment without requiring removal of said lid and without compromising reservoir sanitation.

2. The condiment dispenser of claim 1 wherein said pump comprises a variable volume pump.

3. The condiment dispenser of claim 1 wherein said handle has a plurality of thumb screws carried thereby each having an asymmetric head rotatable with respect thereto, said thumb screws being located on said handle at the exterior of said lid; said heads being receivable in one orientation into and through a widened slot portion formed in said lid without interference, at least one of said heads being rotatable relative to said handle away from said one orientation to preclude reception into said widened slot portion whereby said at least one head comprises one of said stops engageable with said lid to define an end limit to handle reciprocation.

4. The condiment dispenser of claim 1 wherein said handle carries a bow with inturned ends at the exterior of said lid, said bow having a bight portion received through said handle, and said inturned ends of said bow extending into one of a plurality of aligned pairs of open side ports formed in said handle, said bow defining said stop engageable with said lid to define an end limit to handle reciprocation depending upon the specific pair of open side ports into which said inturned ends are received.

5. The condiment dispenser of claim 4 wherein said bight portion of said bow is received through said handle adjacent said pivotal mounting of said bow to said handle.

6. The condiment dispenser of claim 1 wherein each of said draw tube and said dispense tube has a check valve associated therewith.

7. A condiment dispenser, comprising:
a reservoir for containing a selected condiment;
a variable volume pump within said reservoir and including a draw tube and a dispense tube each having a check valve associated therewith; and
a lid mounted on said reservoir, said lid having a handle pivotally mounted thereon at the exterior of said lid and reciprocal to operate said pump, said handle being associated with a pair of adjustable stops at the exterior of said lid for limiting the handle stroke length for variably selecting the dispensed volume of the selected condiment without requiring removal of said lid and without compromising reservoir sanitation;
said handle having a plurality of thumb screws carried thereby each having an asymmetric head rotatable with respect thereto, said heads being receivable in one orientation into and through a widened slot portion formed in said lid without interference, at least one of said heads being rotatable relative to said handle away from said one orientation to preclude reception into said widened slot portion whereby said at least one head comprises one of said stops engageable with said lid to define an end limit to handle reciprocation.

8. A condiment dispenser, comprising:
a reservoir for containing a selected condiment;
a variable volume pump within said reservoir and including a draw tube and a dispense tube each having a check valve associated therewith; and
a lid mounted on said reservoir, said lid having a handle pivotally mounted thereon to operate said pump, said handle being associated with a pair of adjustable stops for limiting the handle stroke length for variably selecting the dispensed volume of the selected condiment without requiring removal of said lid and without compromising reservoir sanitation;
said handle carrying a bow with inturned ends, said bow having a bight portion received through said handle, and said inturned ends of said bow extending into one of a plurality of aligned pairs of open side ports formed in said handle, said bow defining said stop engageable with said lid to define an end limit to handle reciprocation depending upon the specific pair of open side ports into which said inturned ends are received.

9. The condiment dispenser of claim 8 wherein said bight portion of said bow is received through said handle adjacent said pivotal mounting of said bow to said handle.
